(19) United States
(12) Patent Application Publication
(10) Pub. No.: US 2010/0235725 A1
(43) Pub. Date: Sep. 16, 2010

(54) SELECTIVE DISPLAY OF ELEMENTS OF A SCHEMA SET

(75) Inventors: Peter F. Drayton, Redmond, WA (US); Tim A. Laverty, Seattle, WA (US); Fabian O. Winternitz, Sammamish, WA (US); Swapna Guddanti, Bothell, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/400,812

(22) Filed: Mar. 10, 2009

(51) Int. Cl. G06F 3/048; G06F 17/00

(52) U.S. Cl. 715/234; 715/810; 715/853

(57) ABSTRACT

A schema browsing system is described herein that allows a user to quickly consume information about one or more XML schema elements of a schema set that the user is interested in and to visualize relationships of other elements to the elements of interest, irrespective of how the elements are physically stored and subdivided in XSD or other schema files. The system displays elements selected by the user and excludes portions of the schema set that are not related to the displayed elements. The system displays the selected elements along with a visual indication of the relationships between the selected elements. By repeating the process of selecting elements, the user can use the system to build up a display that includes only those elements and relationships in which the user is interested.

### BACKGROUND

An Extensible Markup Language (XML) schema is a description of a type of XML document, typically expressed in terms of constraints on the structure and content of documents of that type beyond the basic syntactical constraints imposed by XML itself. One reason for defining an XML schema is to formally describe and validate one or more XML documents that adhere to the schema. Designers have developed languages specifically to express XML schemas. The Document Type Definition (DTD) language, which is included in the XML 1.0 standard, is a schema language that is of relatively limited capability. Two other popular, more expressive XML schema languages are XML Schema (W3C) and RELAX NG.

The mechanism for associating an XML document with a schema varies according to the schema language. The association may be achieved via markup within the XML document itself, or via some external means. The process of checking to see if an XML document conforms to a schema is called validation, which is separate from XML's core concept of syntactic well formedness. Valid XML documents are well formed, but do not necessarily correctly adhere to a schema without validation. DTD-validating parsers are most common, but some support W3C XML Schema or RELAX NG as well. Documents are valid when they satisfy the requirements of the schema with which they have been associated. These requirements typically include such constraints as elements and attributes that may be included, permitted structure of elements, how the schema will interpret character data (e.g., number, date, Uniform Resource Locator (URL), Boolean), and so forth.

XML Schema, published as a World Wide Web Consortium (W3C) recommendation in May 2001, is one of several XML schema languages and is often referred to as XSD based on the extension of XML Schema Documents (XSD) that implement XML Schema (in the draft of the next version, 1.1, the W3C has chosen to adopt XSD as the preferred name). XSD was the first separate schema language for XML to achieve Recommendation status by the W3C. Like all XML schema languages, XSD can be used to express a set of rules to which an XML document adhering to the schema conforms in order to be considered valid according to that schema. However, unlike most other schema languages, XSD was also designed with the intent that determination of a document's validity would produce a collection of information adhering to specific data types. Such a post-validation information set can be useful in the development of XML document processing software. Microsoft's XML Library, MSXML 6.0 provided support for XSD starting in December 2006.

An XML schema using XSD often includes many documents. Technically, a schema is an abstract collection of metadata that includes a set of schema components, such as element and attribute declarations and complex and simple type definitions. These components are usually created by processing a collection of schema documents that contain the source language definitions of these components. Schema documents are organized by namespace: each named schema component belongs to a target namespace, and the target namespace is a property of the schema document as a whole. In addition, a particular document without a target namespace specified (sometimes called a chameleon) allows nodes in a schema to “assume” the namespace of a document that imports or includes the first document. A schema document may include other schema documents for the same namespace, and may import schema documents for a different namespace.

Because XML schemas using XSD are so effective, designers have built very large and complex schemas that include many separate XSD files and nodes (e.g., hierarchical XML elements). Examples of XSD usage for complex domain models range from the health care industry to finance and more. XML schema sets can include an extremely large amount of data. To get an overview of the data in a schema set, users typically search through multiple included and imported XSD files. Finding all related files, namespaces, and nodes in a schema set can be very difficult and frustrating. The user typically cannot quickly find the files, namespaces, or nodes in which the user is interested. One way of solving this problem is by showing the schema set contents in a hierarchal tree view browser. This type of browser is typically based on the logical structure of the schema set, such as (at the highest level) files, then the hierarchy of nodes in each file, and so forth. However, this raises another problem in that the tree view may be very large and the user still may not be able to extract the information about the schema set that the user is interested in, such as a particular node and the relationships of other nodes to that node. FIG. 1 illustrates a typical XSD file 110 that defines an address, a tree view 120 that graphically depicts the schema defined by the XSD file, and an XML file 130 that adheres to the schema. Even the schema for data as simple as an address can fill a page. When representing real-world data relationships (such as all of the employee functions in a company), the schema size can quickly become overwhelming to the user.

### SUMMARY

A schema browsing system is described herein that allows a user to quickly consume information about one or more XML nodes of an XML document or schema set that the user is interested in and to visualize relationships of other nodes to the node of interest, irrespective of how the nodes are physically stored and subdivided in XSD or other schema files. A user selects a schema set to open and use with the system, and then selects a node or other element from the schema set. The system displays the selected node and optionally displays additional related information about the node. The system may receive additional nodes selected by the user for display. When a user selects additional nodes, the system displays the nodes along with a visual indication of the relationships between the additional selected nodes and any nodes already displayed.

By repeating this process, the user can build up a display that includes only those nodes and relationships in which the user is interested. Unlike previous XML schema displays, the schema browsing system provides at least one view that does not burden the user with a potentially large number of nodes in the schema that are not relevant to the information about the schema that the user is currently interested in. The system also does not expect the user to be aware of the layout of files in which the nodes are stored, and the user can potentially select nodes from many different schema files for the system to display. Thus, the schema browsing system allows the user to construct a display that is restricted to the XML schema nodes of interest to the user, so that the user can view the nodes the user is interested in and any relationships between those nodes in a compact display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a typical XSD file displayed in a tree view.

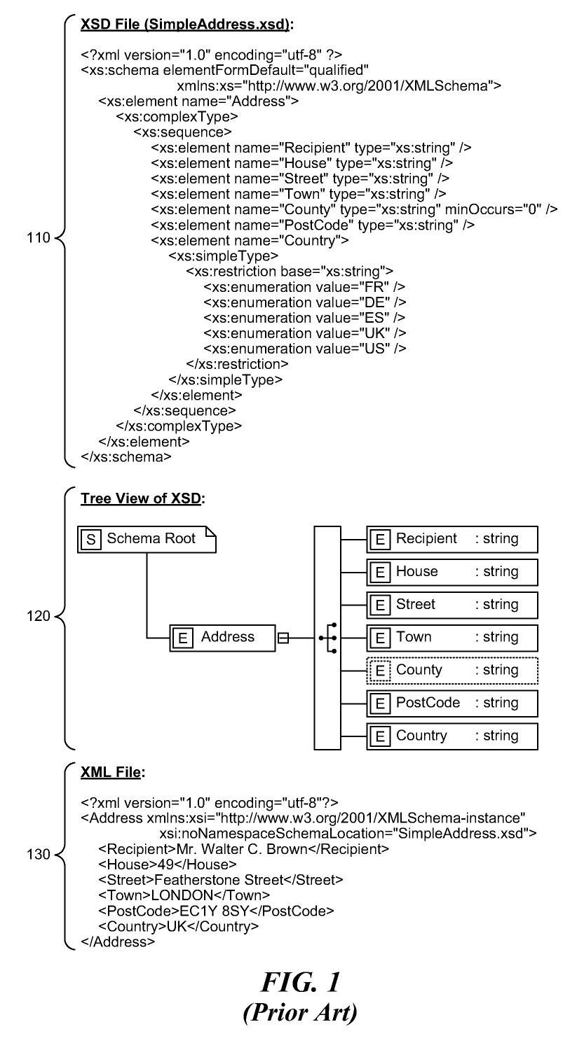

FIG. 2 is a block diagram that illustrates components of the schema browsing system, in one embodiment.

FIG. 3 is a flow diagram that illustrates the processing of the system to display selected schema elements, in one embodiment.

FIG. 4 is a flow diagram that illustrates the processing of the system when a user edits a schema set a portion of which the system is displaying in a compact schema view, in one embodiment.

### DETAILED DESCRIPTION

A schema browsing system is described herein that allows a user to quickly consume information about one or more XML nodes of an XML document or schema set that the user is interested in and to visualize relationships of other nodes to the nodes of interest, irrespective of how the nodes are physically stored and subdivided in XSD or other schema files. The nodes of interest may include files, namespaces, nodes, or any other element of the XML schema. Relationships include many types of associations between nodes. For example, a node may be dependent on another node 2-3 levels away. In some embodiments, the schema browsing system displays the nodes of interest on a hyperbolic 2-dimensional (2D) browser surface, called a graph view, that is a compact representation of the schema nodes in which the user is interested. The graph view allows the user to view all related nodes of interest (with their relationships) in one view. A user starts by selecting a schema set to open and use with the system. For example, the user may navigate to an XSD file in the set in an XML schema browsing application, such as Microsoft's XML Schema Explorer. The application may display the selected schema set in a tree view or other typical exhaustive XML schema display. Next, the user selects a node or other element from the schema set for display in the graph view. For example, the user may drag a node from the tree view to a surface of the graph view. The system displays the selected node in the graph view and optionally displays additional related information about the node. For example, the system may show properties associated with the selected node or nodes related to the selected node (e.g., siblings, children, and so forth).

The system may receive additional nodes selected by the user for display in the graph view. For example, the user may drag another node from the tree view to the graph view. Those of ordinary skill in the art will recognize numerous user interface paradigms for receiving a selection, such as a node to display in the graph view, from the user. When a user selects additional nodes, the system displays the nodes in the graph view along with lines or another visual indication of the relationships between the additional selected nodes and any nodes already displayed in the graph view. By repeating this process, the user can build up a display in the graph view that includes only those nodes and relationships in which the user is interested. Unlike previous XML schema displays, the schema browsing system provides at least one view that does not burden the user with a potentially large number of nodes in the schema that are not relevant to the information about the schema that the user is currently interested in. The system also does not expect the user to be aware of the layout of files in which the nodes are stored, and the user can potentially select nodes from many different schema files for the system to display in the graph view. Thus, the schema browsing system allows the user to construct a display that is restricted to the XML schema nodes of interest to the user, so that the user can view the nodes the user is interested in and any relationships between those nodes in a compact display.

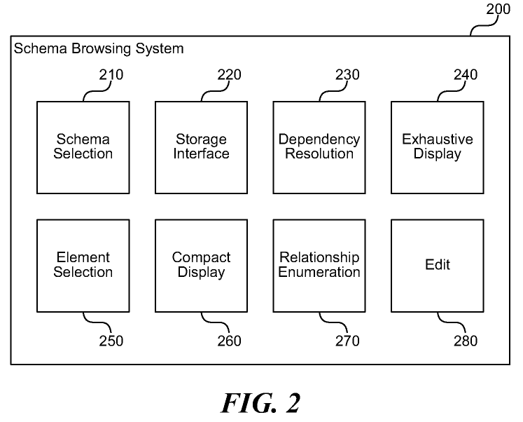

FIG. 2 is a block diagram that illustrates components of the schema browsing system, in one embodiment. The schema browsing system 200 includes a schema selection component 210, a storage interface component 220, a dependency resolution component 230, an exhaustive display component 240, an element selection component 250, a compact display component 260, a relationship enumeration component 270, and an edit component 280. Each of these components is described in further detail herein.

The schema selection component 210 receives from the user a selection of a schema set to open and use with the schema browsing system 200. The system 200 may be embodied in an XML editing application or may be an add-on component to an integrated development environment (IDE). The application or IDE provides a user interface through which the user can browse and open files stored on a storage device. For example, an IDE may provide a file open dialog through which the user can select files from a hard drive attached to the computer on which the system runs.

The storage interface component 220 provides an interface with one or more storage devices on which a schema set is stored. The schema selection component 210 invokes the storage interface component 220 to browse files stored on a storage device and to open a schema set file selected by the user. The storage device may include a hard drive, removable storage device (e.g., a USB flash memory device), a network resource (e.g., a storage area network (SAN) or web service), or any other type of storage device. The storage interface component 220 may invoke application programming interfaces (APIs) provided by an operating system to enumerate and open files selected by the user.

The dependency resolution component 230 identifies files associated with an XML schema set. For example a user may select one file associated with the XML schema set that includes (e.g., via an XML include or import directive) multiple other files associated with the schema set. XML schema designers can divide XML schema sets according to many schemes. For example, some XML schema designers prefer to define each XML schema data type in a separate XSD file. An XSD file may include many data types and may include a reference to XSD files that define each included data type. The dependency resolution component 230 identifies referenced XSD or other files and opens files that include information related to the XML schema set selected by the user.

The exhaustive display component 240 displays information about an XML schema set in the long form typical of previous schema browsers. The exhaustive display component 240 presents a hierarchical view, such as a tree view, that includes all of the elements (or elements of particular types, like nodes) that are defined by the selected XML schema set. The exhaustive display component 240 often produces a very large display that is scrolled across multiple screens based on the large size of many XML schemas. The schema browsing system 200 displays the exhaustive display so that the user can select individual XML schema elements for inclusion in a more compact display. In some embodiments, the schema browsing system 200 may not include an exhaustive display component 240 in favor of other methods of allowing the user to select elements, such as by typing an element's name (e.g., using a text box with auto-completion as the user types).

The element selection component 250 receives an element selection from the user. For example, the user may select an element displayed by the exhaustive display component 240 or through another user interface. Alternatively or additionally, the user may select particular XML elements from an XSD file opened in a text editor or a syntactic editor that displays the contents of the XSD file. The element selection component 250 may also receive an element selection using drag and drop or other user interface paradigms commonly available in the art. The element selection component 250 provides the selected element (or elements) to the compact display component 260 for display to the user.

The compact display component 260 displays a subset of an XML schema in a compact schema view based on elements of the XML schema identified by the user. The display may use boxes or other common user interface building blocks to display each element. The user can identify elements based on a particular task the user is performing that, for example, may involve understanding a particular portion of the XML schema. The compact display component 250 displays the XML elements selected by the user in a hyperbolic 2D browser or other view suitable for displaying information about the selected elements. In some embodiments, the compact display component 260 displays visual indications, such as lines and/or splines between displayed elements, that indicate relationships between elements displayed by the compact display component 260. The compact display component 260 provides information to the user about a selected subset of the XML schema in a way that does not include extraneous schema elements so that the user can understand the selected subset of the XML schema and have a smaller volume of information to process.

The relationship enumeration component 270 identifies relationships between XML schema elements selected by the user. The user may select schema elements from many different XSD files or sections of a schema set. Based on the size of an XML schema and the different files in which the selected schema elements are stored it may not be clear to the user at the time of selection whether the schema elements are related at all. The relationship enumeration component 270 determines whether the selected elements are related by traversing the XML schema and identifying relationships between the elements. If the relationship enumeration component 270 identifies a relationship, then the component 270 provides information about the relationship to the compact display component 260 for display to the user. Unlike the exhaustive display, which includes each element hierarchically and can display a direct relationship between any two hierarchically related elements, the compact display may include two elements that are related through other elements not displayed in the compact display. In such cases, the compact display component 260 may add elements that lie between the two selected elements to the compact display so that the user can visualize the relationship. The component 260 may provide a visual indication (e.g., graying out or using a different color) that conveys to the user that the user did not select the added elements.

The edit component 280 receives modifications from the user to a file that stores an element of the schema set. For example, a user may open a file that stores a node displayed in the compact schema view and use the edit component 280 to modify the file. The user can modify a file in many ways, such as by deleting a schema node from the file, adding a schema node to the file, adding a new relationship between schema nodes stored in the file, and so forth. The edit component 280 may invoke the compact display component 260 and relationship enumeration component 270 to update dynamically the compact schema view based on modifications to the schema set received from the user. Alternatively or additionally, the compact display component 260 may listen (e.g., by registering an event handler through a notification interface) for changes in the schema set (e.g., those received by the edit component 280) and react to received changes by updating the display.

The computing device on which the system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

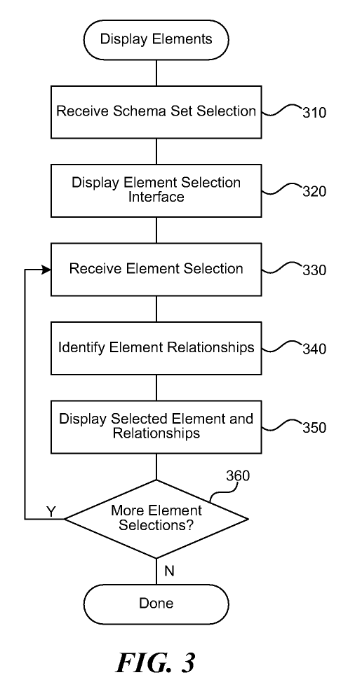

FIG. 3 is a flow diagram that illustrates the processing of the system to display selected schema elements, in one embodiment. In block 310, the system receives from a user a selection of a schema set to open and use with the system. For example, the user may navigate to an XSD file in the set in an XML schema browsing application. Continuing in block 320, the system displays to the user an interface for selecting elements of the selected schema set. For example, the XML schema browsing application may display the selected schema set in a tree view or other typical exhaustive XML schema display from which the user can select (e.g., by dragging or clicking and selecting a menu item) an element. Continuing in block 330, the system receives a selection of an element from the interface for selecting elements for display in a compact schema view. For example, the user may drag a node from the tree view to a surface of the compact schema view.

Continuing in block 340, the system identifies any relationships between selected elements. For example, the system may search the hierarchy of the schema set for each selected element to identify relational connections between the elements. Continuing in block 350, the system displays the selected element and any identified relationships in the compact schema view. The system also optionally displays additional related information about the selected element. For example, the system may show properties associated with the selected element or nodes related to the element (e.g., siblings, children, and so forth). Continuing in decision block 360, if the user is finished selecting elements, then these steps conclude, else the system loops to block 330 to receive the next element selection. Alternatively or additionally, the system may receive additional elements through other user interface paradigms, such as semantic queries.

The system continues in this way, adding additional elements selected by the user to the compact schema view until the user is done viewing elements. When a user selects additional elements, the system displays the elements in the compact schema view along with lines or another visual indication (e.g., splines) of the relationships between the additional selected elements and any elements already displayed in the compact schema view. The user may also remove elements (not shown) and add other elements to build up additional subsets of elements to view in the compact schema view. By repeating this process, the user can build up a display in the compact schema view that includes only those elements and relationships in which the user is interested.

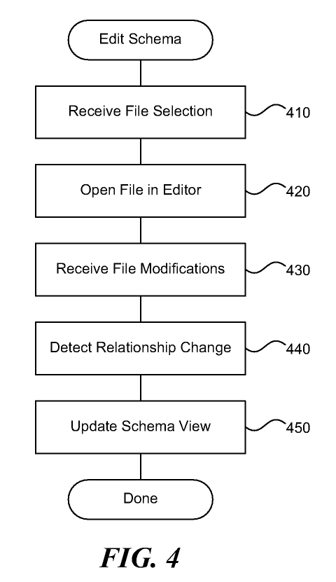

FIG. 4 is a flow diagram that illustrates the processing of the system when a user edits a schema set a portion of which the system is displaying in a compact schema view, in one embodiment. In block 410, the system receives a selection of a file associated with a displayed schema element that the user wants to edit. For example, the user may right click on a displayed schema element and select an edit operation from a context menu. Continuing in block 420, the system opens the selected file in an editor. For example, the system may provide an XML editor that displays XSD files in a hierarchical view with colorized syntax elements. Continuing in block 430, the system receives one or more modifications to the file from the user. For example, the user may add a node, remove a node, change a node property, or modify a relationship between nodes.

Continuing in block 440, the system detects a change in a relationship between an element displayed in the compact schema view and another element in the schema set. For example, the system may detect that a user has subordinated a displayed element in an XML hierarchy to another element. Continuing in block 450, the system updates the compact schema view to indicate visually the change in the relationship. For example, if the user adds a relationship to a node previously displayed in the compact schema view to a node not displayed in the schema view, the system may add the node not displayed in the schema view to the compact schema view and draw a line between the two nodes to indicate the relationship to the user. This allows the user to see dynamically the changes the user makes to an XSD or other schema file. After block 450, these steps conclude.

In some embodiments, the schema browsing system allows the user to select a displayed schema element to open and edit the file that stores the displayed schema element. For example, after a user has built up a graph view with nodes in which the user is interested, the user may want to see the actual definition of the nodes or modify the relationships between nodes based on information the user learned from the graph view. The system allows the user to select an element, such as by double clicking on the element in the graph view, and the system opens the file associated with the element in a text or syntactic editor where the user can view and make modifications to the element. The system may store a file path that identifies the location of a file in a data structure that defines a particular element in memory when the system initially opens the XML schema set. When the user selects the element, the system retrieves the file path from the data structure and opens the file. The system may also store additional information, such as the line number in the file that contains the element definition, so that the system can jump to the position in the file of the selected element.

In some embodiments, the schema browsing system allows the user to dynamically add and remove elements from the graph view. For example, the user may initially be interested in determining any relationship between a first and second node, then be interested in determining any relationship between the first node and a third node without the confusion of viewing the second node. Thus, the user may initially add the first and second nodes to the graph view then remove the second node from the graph view and add the third node to the graph view. The user may also want to view relationships of a particular type and in some embodiments the system receives information from the user about the types of relationships to include or exclude in the displayed view. In this way, the user can view many different subsets of the schema set with as much or as little extraneous information as the user desires.

In some embodiments, the schema browsing system provides operations that can be performed on a selected element in the graph view. For example, the user may select a node and invoke an operation that adds a base type of the node to the graph view. Other operations may add all references of a selected element, add all referrers to the selected element, remove all elements in the graph display except the selected element (or elements), and so forth. As another example, the system may provide an option through which the user can select an element and request that the system add elements that have any or a particular type of relationship with the selected element. Those of ordinary skill in the art will recognize many common operations generally associated with manipulating sets of user interface elements such as the elements the system displays in the graph view.

In some embodiments, the schema browsing system dynamically updates the graph view as a user modifies the schema set. For example, using the functionality described herein, a user may open an XSD file associated with the schema set and begin typing within the file. The user's edits may change the relationships between nodes, add new nodes, remove nodes, and so forth. The schema browsing system updates the graph view to reflect the changes made by the user. For example, if the user adds a relationship to a node that is displayed in the graph view, then the system may add the new related elements to the graph view and provide a visual indication of the relationship to the user. In some embodiments, the schema browsing system allows the user to update the graph view directly, such as by connecting elements between which the user wants to form a relationship, deleting nodes that the user wants to remove from the schema, and so forth.

In some embodiments, the schema browsing system determines a layout for the elements in the graph view based on relationships between the elements. For example, the system may select a layout that reduces a number of relationship lines that cross in the display. By moving an element to a different portion of the display in relation to other elements, the system can produce a cleaner, more readable display while still conveying the same information (e.g., elements and relationships) to the user. Those of ordinary skill in the art will recognize several common algorithms for reducing distance and line crossings between related nodes in a display like the graph view described herein. Alternatively or additionally, the system may receive manual adjustments to the displayed layout from a user and persist the user's changes to the layout for later requests to display the schema.

From the foregoing, it will be appreciated that specific embodiments of the system have been described herein for purposes of illustration, but that various modifications may be made without deviating from the spirit and scope of the invention. For example, although XML schemas have been described herein, the system could also be applied to other schema types and modeling languages (e.g., a database schema or UML diagram) to allow a user to work with large amounts of data. Accordingly, the invention is not limited except as by the appended claims.

I/We claim:

1. A computer-implemented method for displaying selected elements of an XML schema set, the method comprising:
receiving from a user a selection of a schema set to open;
displaying to the user an interface for selecting elements of the selected schema set;
receiving from the interface for selecting elements a selection of an element for display in a compact schema view;
identifying any relationships between the selected element and other elements in the schema;
displaying the selected element and any identified relationships in the compact schema view, wherein the compact schema view includes elements that the user selects and identified relationships but does not include each element in the selected schema set,
wherein the preceding steps are performed by at least one processor.

2. The method of claim 1 wherein the schema set is stored in one or more XSD files and receiving the selection of the schema set comprises receiving an identification of an XSD file.

3. The method of claim 1 wherein displaying an interface for selecting elements comprises displaying the selected schema set in a tree view from which the user can select an element.

4. The method of claim 1 wherein receiving the selection of the element comprises receiving an indication that a user dragged the element from the interface for selecting elements to the compact schema view.

5. The method of claim 1 wherein identifying relationships comprises searching a hierarchy associated with the schema set for the selected element to identify relational connections between the selected element and other elements.

6. The method of claim 1 wherein displaying the selected element in the compact schema view comprises displaying additional related information about the selected element.

7. The method of claim 1 further comprising
receiving a selection of a second element;
identifying any relationships between the second element and other elements; and
displaying the second selected element with the first selected element and any identified relationships in the compact schema view.

8. The method of claim 1 further comprising receiving an indication from the user to remove an element from the compact schema view and removing the element from the compact schema view.

9. The method of claim 1 further comprising receiving an indication from the user to edit the selected element and opening an editor for editing the selected element.

10. A computer system for viewing a subset of a schema set, the system comprising:
a processor and memory configured to execute software instructions;
a schema selection component configured to receive from a user a selection of a schema set to open with the system;
a storage interface component configured to provide an interface with one or more storage devices on which a schema set is stored, wherein the schema selection component is further configured to invoke the storage interface component to browse files stored on a storage device and to open a schema set file selected by the user;
a dependency resolution component configured to identify files associated with the selected schema set;
an exhaustive display component configured to display information about the selected schema set that includes a logical view of each element of one or more types in the schema set;
an element selection component configured to receive from the user an element selection from elements of the selected schema set;
a compact display component configured to display a subset of the selected schema set in a compact schema view based on elements of the XML schema identified by the user; and
a relationship enumeration component configured to identify relationships between schema elements selected by the user via the element selection component.

11. The system of claim 10 wherein the schema selection component is part of an integrated development environment (IDE) that provides a user interface through which the user can browse and open files stored on a storage device.

12. The system of claim 10 wherein the dependency resolution component is further configured to resolve one or more files referenced by the selected schema set based on at least one XML import directive included in at least one file associated with the selected schema set.

13. The system of claim 10 wherein the element selection component is further configured to provide the selected element to the compact display component for display to the user.

14. The system of claim 10 wherein the compact display component is further configured to display a box for each element in the subset of the selected schema set and a visual indication for each identified relationship between elements in the subset of the selected schema set.

15. The system of claim 10 wherein the relationship enumeration component is further configured to identify relationships across multiple XSD files that define the selected schema set by traversing the selected schema set and identifying relationships between the elements in the selected schema set.

16. The system of claim 10 further comprising an edit component configured to receive modifications from the user to a file that stores the selected element of the schema set and wherein the compact display component and relationship enumeration component are further configured to receive a notification of the modifications and to dynamically update the compact schema view based on the modifications to the schema set received from the user.

17. A computer-readable storage medium comprising instructions for controlling a computer system to display edits to a schema set, wherein the instructions, when executed, cause a processor to perform actions comprising:
receiving from a user a selection of a file to edit, wherein the file is associated with a schema element displayed in a compact schema view that displays a subset selected by the user of the schema set;
opening the selected file in an XML editor;
receiving from the user one or more modifications to the file;
detecting a change in a relationship between an element displayed in the compact schema view and another element in the schema set; and
updating the compact schema view to indicate visually the detected change in the relationship.

18. The computer-readable medium of claim 17 wherein the XML editor displays XSD files in a hierarchical view and provides a user interface through which the user can modify the file.

19. The computer-readable medium of claim 17 wherein detecting the change in the relationship comprises detecting that the user added a relationship to a first element previously displayed in the compact schema view to a second element not previously displayed in the compact schema view, and wherein updating the compact schema view comprises adding the second element to the compact schema view and drawing a visual indication between the first element and second element to indicate the added relationship to the user.

20. The computer-readable medium of claim 17 further comprising determining a layout for elements in the compact schema view based on relationships between the elements and updating the layout when a change is detected in a relationship.
